(19) United States
(12) Patent Application Publication
(10) Pub. No.: US 2026/0220397 A1
(43) Pub. Date: Jul. 30, 2026

(54) SMART GLASSES

(71) Applicant: SHIKUMI CO., LTD., Tokyo (JP)

(72) Inventor: Toshiyuki Kato, Saitama (JP)

(21) Appl. No.: 19/179,108

(22) Filed: Apr. 15, 2025

(30) Foreign Application Priority Data
Dec. 24, 2024 (JP) 2024-227043
Feb. 6, 2025 (JP) 2025-018275

(51) Int. Cl. G06F 40/58; G02B 27/01; G06V 20/20; G06V 40/20; G10L 13/027; G10L 15/26

(52) U.S. Cl. CPC G06F 40/58; G02B 27/0172; G06V 20/20; G06V 40/28; G10L 13/027; G10L 15/26; G02B 2027/0138; G02B 2027/0141; G02B 2027/0178

(57) ABSTRACT

Smart glasses that enable people using different information delivery ways, such as languages, to have smooth bidirectional communication, such as a conversation, are provided. Smart glasses include a lens unit that allows a wearer to visually recognize a front field of vision, and include an internal display unit that displays information for the wearer and a transmission-type external display unit that displays, in the lens unit, information for a conversation counterpart that the wearer faces.

### CROSS-REFERENCE TO RELATED APPLICATION

This patent application claims the benefit and priority of the Japanese Patent Application No. 2024-227043, filed with the Japanese Patent Office on Dec. 24, 2024, and Japanese Patent Application No. 2025-018275, filed with the Japanese Patent Office on Feb. 6, 2025, the disclosure of which are each incorporated by reference herein in their entireties as part of the present application.

### BACKGROUND OF THE INVENTION

### Field of the Invention

The present invention relates to smart glasses.

### Description of the Related Art

In the related art, glasses type display devices that translate speakers'words into other languages and display the translated words as text, in other words, smart glasses are known (see Japanese Patent No. 5666219, Chinese Patent No. 112764549, and Chinese Utility Model Laid-Open Nos. 220913466 and 221351861). In a case where people using different languages have a conversation, for example, the smart glasses in the related art as disclosed in Japanese Patent No. 5666219 and Chinese Patent No. 112764549 can deliver what a conversation counterpart desires to say to a wearer of the glasses by the smart glasses recognizing words (in English or the like) that the conversation counterpart speaks, translating the words into words (in Japanese or the like) that the wearer of the glasses speaks, and displaying translated text (letters) on a display formed on a lens of the glasses.

Also, the smart glasses disclosed in Chinese Utility Model Laid-Open Nos. 220913466 and 221351861 include projection-type display equipment that projects and displays a video for a wearer of the glasses, instead of the display on the lens. The display equipment is provided in a rim constituting a frame of such smart glasses and can deliver what a conversation counterpart desires to say to the wearer of the glasses by directly projecting text (letters) after translation within a field of vision of the wearer from the display equipment.

However, the smart glasses in the related art are not adapted to deliver words (in Japanese or the like) that the wearer speaks to the counterpart of the conversation in words (in English or the like) that the conversation counterpart speaks. In other words, the smart glasses in the related art only have a function of displaying external information for its wearer via the glasses and can only perform unidirectional information delivery.

The present invention was made in view of such a problem, and an object thereof is to provide smart glasses that enable people using different information delivery ways, such as languages, to have smooth bidirectional communication, such as a conversation.

### SUMMARY OF THE INVENTION

Smart glasses according to disclosed embodiments of the present invention are smart glasses including a lens unit that allows a wearer to visually recognize a front field of vision, the smart glasses including: an internal display unit that displays information for the wearer; and a transmission-type external display unit that displays, in the lens unit, information for a conversation counterpart that the wearer faces.

According to the smart glasses of the present invention, people using different information delivery ways, such as languages, can have smooth bidirectional communication, such as a conversation.

The present summary is provided only by way of example and not limitation. Other aspects of the present invention will be appreciated in view of the entirety of the present disclosure, including the entire text, claims, and accompanying figures.

### BRIEF DESCRIPTION OF THE DRAWINGS

FIG. 1 is a perspective view of smart glasses according to a first embodiment;

FIG. 2 is a schematic view of a lens unit located between a wearer and a conversation counterpart when seen from a side according to the first embodiment;

FIG. 3 is a hardware configuration diagram of the smart glasses;

FIG. 4 is a software module configuration diagram of a translation program;

FIG. 5 is a network configuration diagram between the smart glasses and a server in relation to translation;

FIG. 6 is a front view of the smart glasses illustrating a text display mode on an external display unit according to the first embodiment;

FIG. 7 is a front view of the smart glasses illustrating another text display mode on the external display unit according to the first embodiment;

FIG. 8 is a perspective view of smart glasses according to a second embodiment;

FIG. 9 is a front view of the smart glasses illustrating a text display mode on an external display unit according to the second embodiment;

FIG. 10 is a perspective view of smart glasses according to a third embodiment;

FIG. 11 is a schematic view of a lens unit located between a wearer and a conversation counterpart when seen from a side according to the third embodiment;

FIG. 12 is a front view of the smart glasses illustrating a text display mode on an external display unit according to the third embodiment;

FIG. 13 is a front view of the smart glasses illustrating another text display mode on the external display unit according to the third embodiment;

FIG. 14 is a perspective view of smart glasses according to a fourth embodiment;

FIG. 15 is a front view of the smart glasses illustrating a text display mode on an external display unit according to the fourth embodiment;

FIG. 16 is a side view when a wearer wears smart glasses according to a fifth embodiment;

FIG. 17 is a partial perspective view of smart glasses when seen from inside (a side of a wearer) according to a modification; and

FIG. 18 is a schematic view of a lens unit and display equipment located between the wearer and a conversation counterpart in the case of FIG. 17 when seen from a side.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF THE INVENTION

Hereinafter, smart glasses 1 according to each embodiment of the present invention will be described with reference to the drawings.

### First Embodiment

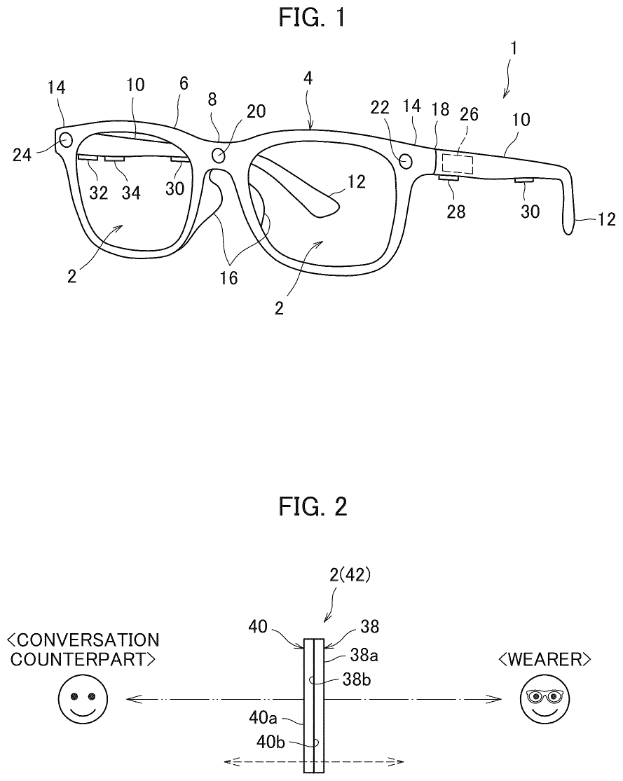

FIG. 1 illustrates a perspective view of the smart glasses 1 according to a first embodiment. The smart glasses 1 (hereinafter, simply referred to as glasses 1 in some cases) include left and right lens units 2 that allow a wearer to visually recognize a front field of vision and a frame 4 that supports the lens units 2. In the frame 4, a rim 6 to which the lens units 2 are fixed, a bridge 8 which connects the left and right lens units 2, left and right temples 10 that are brought into contact with ear upper portions of the wearer, left and right temple tips 12 that are formed at distal ends of the temples 10, respectively, left and right end pieces 14 that connect the rim 6 to the respective temples 10, and the like are formed, and furthermore, the glasses 1 also include left and right pads 16 that serve as nose pads, left and right joints 18 that support the temples 10 at the end pieces 14 such that the temples 10 can open and close, and the like.

In the case of the present embodiment, a camera 20 is installed in the bridge 8, and a front facing microphone (second microphone) 22 and a front facing speaker (speaker) 24 are installed in the left and right end pieces 14, respectively. The camera 20 captures images in front of the wearer, the front facing microphone 22 acquires voice uttered by a conversation counterpart, and the front facing speaker 24 delivers voice converted by a voice conversion module 64, which will be described later, to the conversation counterpart. Also, a light source module 26 is incorporated, an operation unit 28 is installed below the light source module 26, and a wearer speaker (voice delivery unit) 30 are installed in the left temple 10 in the order from the side of the joint 18.

On the other hand, a light source module 26, which is similar to the aforementioned light source module and is not illustrated in the drawing, is incorporated, a wearer microphone (first microphone) 32 is installed below the light source module 26, and an operation unit 34 and a wearer speaker (voice delivery unit) 30, which is similar to the aforementioned wearer speaker, are installed in the right temple 10 in the order from the side of the joint 18, which is not illustrated. The wearer microphone 32 acquires voice uttered by the wearer, and each wearer speaker 30 delivers voice converted by the voice conversion module 64, which will be described later, to the wearer.

FIG. 2 illustrates a schematic view of the lens unit 2 located between the wearer and the conversation counterpart when seen from a side in the first embodiment. The lens unit 2 is configured of a compound lens 42 including a transmission-type internal display unit 38 capable of displaying information only for the wearer and a transmission-type external display unit 40 capable of displaying information only for the conversation counterpart. In the case of the present embodiment, the compound lens 42 is formed in each of the left and right lens units 2 separated via the bridge 8 that constitutes the frame 4 of the glasses 1.

The internal display unit 38 is, for example, a light guide plate-type transparent resin lens and is installed on the eye side (inner side) of the wearer in the compound lens 42. Information such as text is displayed on an inner surface (the surface on the side of the wearer) 38a of the internal display unit 38 via the aforementioned light source module 26 in a direction indicated by the one-dotted chain line for the wearer. However, during the display of the information, the information is not displayed on an outer surface (the surface on the side of the conversation counterpart) 38b of the internal display unit 38.

The external display unit 40 is, for example, a one-sided light emitting transparent OLED (organic EL display) and is installed in the compound lens 42 with a light emitting surface thereof facing the side of the conversation counterpart (outer side). Information such as text is displayed on the outer surface (the surface on the side of the conversation counterpart) 40a of the external display unit 40 in the direction indicated by the two-dotted chain line for the conversation counterpart.

However, during the display of the information, the information is not displayed on the inner surface (the surface on the side of the wearer) 40b of the external display unit 40. Note that the compound lens 42 is transparent as a whole and the wearer and the conversation counterpart can thus visually recognize each other through the lens unit 2 from each other as indicated by the dashed line.

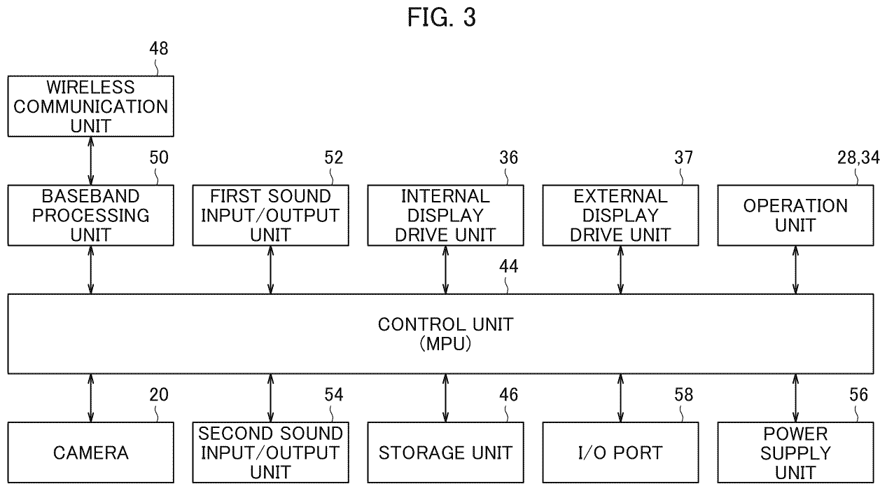

FIG. 3 illustrates a hardware configuration diagram of the smart glasses 1. A translation program as application software is installed in the glasses 1 in the present embodiment. The translation program executes a conversation translation mode, a sign language translation mode, and an image translation mode, which will be described later. In the conversation translation mode, and in a case where people using different languages have a conversation, it is possible to deliver what the conversation counterpart desires to say to the wearer of the glasses 1 by the glasses 1 recognizing words (in English or the like) that the conversation counterpart speaks, translating the words into words (in Japanese or the like) that the wearer of the glasses 1 speaks, and displaying text after the translation on the inner surface 38a of the internal display unit 38. Additionally, this translation program can deliver what the wearer desires to say to the conversation counterpart by the glasses 1 recognizing words (in Japanese or the like) that the wearer of the glasses 1 speaks, translating the words into words (in English or the like) that the conversation counterpart speaks, and displaying text after the translation on the outer surface 40a of the external display unit 40.

More specifically, the glasses 1 include, in addition to the configurations illustrated in FIG. 1, a control unit 44, a storage unit 46, an internal display drive unit 36, an external display drive unit 37, a wireless communication unit 48, a baseband processing unit 50, a first sound input/output unit 52, a second sound input/output unit 54, a power supply unit 56, an I/O port 58, and the like. The control unit 44 includes a micro processing unit (MPU) and executes programs such as a predetermined basic operating system (OS) and middleware.

The control unit 44 controls each part of the glasses 1, constructs a native platform environment and an application execution environment on a software configuration, and performs various kinds of processing necessary for the glasses 1 by executing these programs.

The storage unit 46 includes a random access memory (RAM) as a volatile memory and an internal memory storage, which is a so-called read only memory (ROM) as a nonvolatile memory. A dynamic RAM or the like is used as the RAM in the storage unit 46, and a flash memory or the like is used as the ROM. The storage unit 46 stores an operating system program that controls the glasses 1, a driver program that is used for processing performed by each part in the glasses 1, an application program related to various translations, and the like in the ROM.

In this manner, the ROM corresponds to a storage medium that stores the translation program. In particular, the storage unit 46 stores a basic OS such as a general-purpose OS such as Android (registered trademark), for example, or a dedicated OS uniquely developed by a manufacturer or the like as the operating system program. Also, the storage unit 46 stores various kinds of text data, voice data, image data, and the like and temporarily stores data regarding calculation results generated in the process of calculation in predetermined processing executed by the control unit 44 in the RAM.

The internal display drive unit 36 includes the internal display unit 38 (for example, the light guide plate-type transparent resin lens and the like), which has already been described, and an optical component including the light source module 26 that emits and supplies video light generated by RGB light sources to an incident portion of the internal display unit 38, and further includes various components to display videos, such as a power supply circuit dedicated for the light source module, a video signal processing circuit, and a drive circuit. The external display drive unit 37 includes the external display unit 40 (for example, a display panel main body of the one-sided light emitting transparent OLED) on an output side and further includes various components to display videos, such as a dedicated power supply circuit, a video signal processing circuit, and a light emission drive circuit.

The wireless communication unit 48 functions as a wireless LAN communication section that performs communication via access points for a wireless LAN and a mobile communication section that communicates via base stations for cellular communication and is configured of, for example, a synthesizer, a frequency converter, a high-frequency amplifier, an antenna, and the like. The wireless communication unit 48 executes high-frequency signal processing to perform wireless communication based on a predetermined communication scheme of a wireless LAN, such as IEEE 802.11, with the access points. Also, the wireless communication unit 48 performs high-frequency signal processing to perform wireless communication based on a predetermined communication scheme of cellular communication, such as 3G, Long Term Evolution (LTE), or 5G (fifth generation mobile phone system), with the base stations. Furthermore, the wireless communication unit 48 executes high-frequency signal processing to perform wireless communication based on a predetermined Bluetooth communication scheme with an external communication terminal (such as a smartphone) that supports wireless communication that is compliant with the Bluetooth (registered trademark) standard.

The baseband processing unit 50 executes digital signal processing to perform voice communication and data communication with an external communication terminal and various servers. Connection is established between the baseband processing unit 50 and the aforementioned wireless communication unit 48 via a D/A converter or an A/D converter. The first sound input/output unit 52 is configured of the aforementioned wearer microphone 32 and front facing speaker 24, a signal processing circuit, and the like. The first sound input/output unit 52 converts a voice analog signal input from the wearer microphone 32 into a digital signal by the signal processing circuit and outputs the digital signal to the control unit 44, the baseband processing unit 50, and the like. Also, the first sound input/output unit 52 converts a digital signal input from the control unit 44, the baseband processing unit 50, and the like into an analog signal by the signal processing circuit and outputs the analog signal to the front facing speaker 24. The front facing speaker 24 externally outputs voice based on the input of the analog signal to the conversation counterpart.

The second sound input/output unit 54 is configured of the aforementioned front facing microphone 22 and each wearer speaker 30, a signal processing circuit, and the like. The second sound input/output unit 54 converts a voice analog signal input from the front facing microphone 22 into a digital signal by the signal processing circuit and outputs the digital signal to the control unit 44, the baseband processing unit 50, and the like. Also, the second sound input/output unit 54 converts a digital signal input from the control unit 44, the baseband processing unit 50, and the like into an analog signal by the signal processing circuit and outputs the analog signal to each wearer speaker 30. Each wearer speaker 30 externally outputs voice based on the input of the analog signal to the wearer.

The operation units 28 and 34 are configured of various operation buttons included in the glasses 1, power supply switches as power supply ON/OFF sections, and the like. The operation units 28 and 34 are used when the wearer turns on or off a main body power supply of the glasses 1, selects a menu or a mode related to an operation of an application, provides an instruction to switch a displayed image on a display screen or the like, changes settings necessary for operations of various kinds of software, inputs letter information, and the like.

The camera 20 is configured of a lens, an image capturing device, and the like and is used to image a person who performs a sign language operation, a landscape, and the like. A charge coupled device (CCD) image sensor or a CMOS image sensor is used as the image capturing device. The power supply unit 56 includes a rechargeable battery, a power supply circuit that converts an output of the battery into power of a predetermined voltage and supplies the power to each part of the glasses 1, a charge circuit that is for charging the battery, and the like.

The I/O port 58 is a port for providing connection mainly to a cable that includes a connector of a universal serial bus (USB) Type-C (registered trademark) or Lightening (registered trademark) standard or the like. The control unit 44 can transmit and receive data to and from an external device via the cable connected to the I/O port 58 using the connector. It is also possible to charge the battery of the glasses 1 by supplying power from the outside via the cable connected to the I/O port 58. In this case, the power supplied from the outside via the cable is fed to a charge circuit of the power supply unit 56. The charge circuit charges the battery using the power.

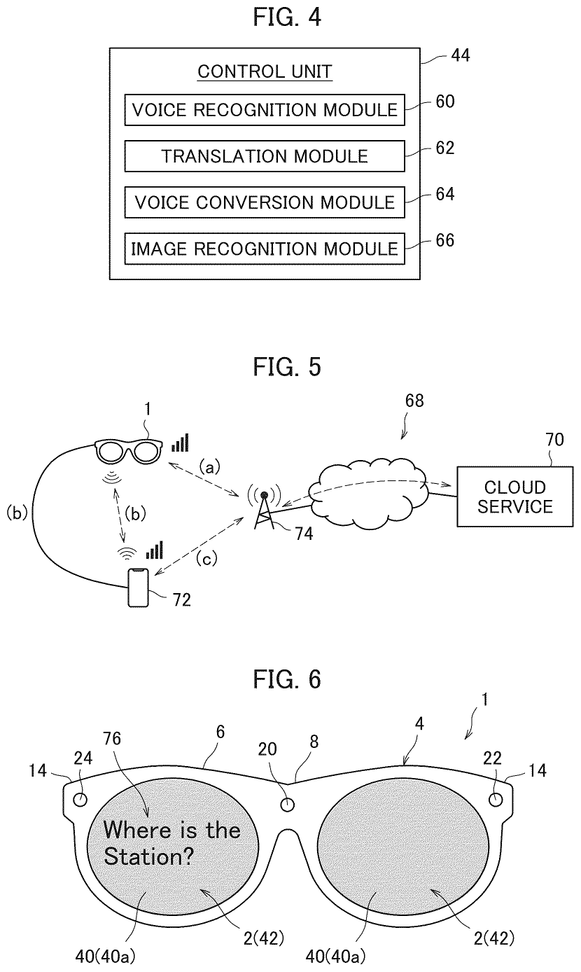

FIG. 4 illustrates a software module configuration diagram of the translation program. The translation program in the present embodiment is configured of a voice recognition module (a first voice recognition unit and a second voice recognition unit) 60, a translation module (a first translation unit, a second translation unit, and a third translation unit) 62, a voice conversion module (a first voice conversion unit, a second voice conversion unit, and a third voice conversion unit) 64, an image recognition module (a first image recognition unit and a second image recognition unit) 66, and the like. The glasses 1 can execute modes such as a conversation translation mode, a sign language translation mode, and an image translation mode, which will be described later, by appropriately using these modules.

### Conversation Translation Mode

The voice recognition module 60 is a software module that recognizes words that the wearer speaks from a digital signal (voice data) of voice of the wearer that has been input from the wearer microphone 32 and has been converted by the first sound input/output unit 52, converts the recognition result into text, and outputs the text as text data. Additionally, the voice recognition module 60 recognizes words that the conversation counterpart speaks from a digital signal of voice of the conversation counterpart that has been input from the front facing microphone 22 and has been converted by the second sound input/output unit 54, converts the recognition result into text, and outputs the text as text data.

The translation module 62 is a software module that translates the text data of the voice recognition result output from the voice recognition module 60 to a different language and outputs the text data after the translation as a translation result. Specifically, the translation module 62 translates the text converted by the voice recognition module 60 from the voice acquired by the wearer microphone 32 into a language that the conversation counterpart can recognize and translates the text converted by the voice recognition module 60 from the voice acquired by the front facing microphone 22 into a language that the wearer can recognize.

The voice conversion module 64 is a software module that converts the text data of the translation result output from the translation module 62 into voice and outputs voice data (digital signal) of the conversion result. Specifically, the voice conversion module 64 converts the text based on an utterance of the wearer that has been translated by the translation module 62 into voice and transmits the voice to the front facing speaker 24, thereby delivering the voice to the conversation counterpart. Also, the voice conversion module 64 converts the text based on an utterance of the conversation counterpart that has been translated by the translation module 62 into voice and transmits the voice to each wearer speaker 30, thereby delivering the voice to the wearer.

For the text based on the utterance of the conversation counterpart that has been translated by the translation module 62, it is possible to select a mode in which the text is delivered to the wearer by displaying the text on the inner surface 38a of the internal display unit 38 as well in addition to the output of the voice to each wearer speaker 30, and it is also possible to select a mode in which the text is delivered to the wearer by displaying the text only on the inner surface 38a of the internal display unit 38 without outputting voice from each wearer speaker 30. Similarly, for the text based on the utterance of the wearer that has been translated by the translation module 62, it is possible to select a mode in which the text is delivered to the conversation counterpart by displaying the text on the outer surface 40a of the external display unit 40 as well in addition to the output of the voice from the front facing speaker 24, and it is also possible to select a mode in which the text is delivered to the conversation counterpart by displaying the text only on the outer surface 40a of the external display unit 40 without outputting voice from the front facing speaker 24.

### Sign Language Translation Mode

The image recognition module 66 is a software module equipped with a function of recognizing a sign language motion of the conversation counterpart from an image (including a video) acquired by the camera 20 and converting content of a conversation indicated by the sign language motion into text data. The text converted by the image recognition module 66 may be displayed on the inner surface 38a of the internal display unit 38, or may be converted into voice by the voice conversion module 64 and output as voice from each wearer speaker 30. Also, both the text display and the voice output may be executed.

### Image Translation Mode

The image recognition module 66 can also recognize and extract text from an image (including a video) acquired by the camera 20. Specifically, the image recognition module 66 extracts text from an image of an explanatory note for a work displayed in an art museum or a museum, a list of dishes on a menu of a restaurant, or the like captured by the camera 20, and the translation module 62 translates the text into a language that the wearer can recognize. The text translated by the translation module 62 may be displayed on the inner surface 38a of the internal display unit 38 or may be converted into voice by the voice conversion module 64 and output as voice from each wearer speaker 30. Also, both the text display and the voice output may be executed.

FIG. 5 illustrates a network configuration diagram of the smart glasses 1 and a server in relation to translation. The processing in each mode described above is preferably performed in a completed manner in the glasses 1 themselves by the control unit 44 executing the translation program installed in the glasses 1 as described above. However, in consideration of the processing load and the amount of power consumption for the processing, and the like of the glasses 1, the processing in each mode may be performed by the glasses 1 directly using a cloud service 70 that is connected to the Internet 68 and provides the processing (voice recognition, translation, voice conversion, image recognition, and the like) as a service (a mode (a) illustrated in FIG. 5) or may be performed by a terminal 72 that implements external computing, such as a smart phone, in response to a request of performing the processing from the glasses 1 (a mode (b) illustrated in FIG. 5).

The processing that the terminal 72 is requested to perform may be performed through local processing in the terminal 72 or may be performed by the terminal 72 using the cloud service 70 (a mode (c) illustrated in FIG. 5). Specifically, it is possible to use a Text To Speech (TTS)-based or Speech To Text (STT)-based application programming interface (API) for any of voice conversion and recognition functions provided as cloud services by Microsoft Corporation, Google LLC, Amazon. com Inc., and the like and to use language translation functions provided by Microsoft Corporation, Google LLC, Amazon. com Inc., DeepL SE, and the like, for example. In a case where the glasses 1 directly use the cloud service 70, processing is performed through cellular wireless communication of 4G LTE or the like via a base station 74 (FIG. 5(a)). Also, in a case where the terminal 72 is requested to perform the processing, wired connection (the solid line in FIG. 5(b)) using a USB or the like is established or wireless connection (the dashed line in FIG. 5(b)) using Bluetooth, Wi-Fi, or the like is established between the terminal 72 and the glasses 1.

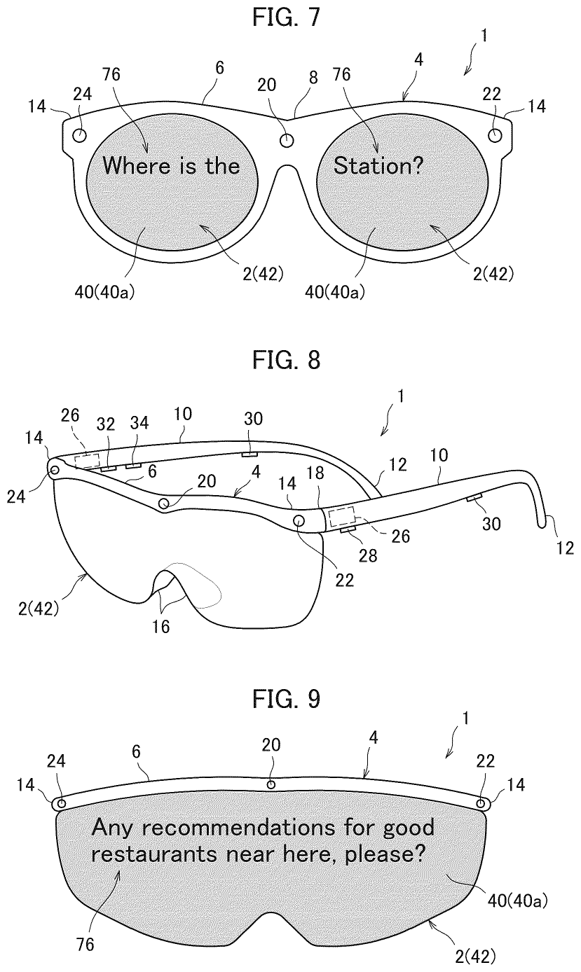

FIG. 6 is a front view of the glasses 1 illustrating a text display mode on the external display unit 40 according to the first embodiment, and FIG. 7 is a front view of the glasses 1 illustrating another text display mode on the external display unit 40 according to the first embodiment. In the case of the first embodiment, the compound lens 42 is formed in each of the left and right lens units 2 separated via the bridge 8 constituting the frame of the glasses 1. Therefore, a series of text 76 may be displayed only on the outer surface 40a of the external display unit 40 in the lens unit 2 on one side as illustrated in FIG. 6, or display of a series of text 76 on the outer surface 40a of the external display unit 40 in the lens unit 2 on one side and display of the next series of text 76 on the outer surface 40a of the external display unit 40 in the lens unit 2 on the other side may be sequentially performed. As illustrated in FIG. 7, a series of text 76 may be continuously displayed across the outer surfaces 40a of the external display units 40 in both the lens units 2.

As described above, the smart glasses 1 according to the present embodiment has the lens units 2 configured of the compound lenses 42 which includes the transmission-type internal display units 38 that can display information only for the wearer, and the transmission-type external display units 40 that can display information only for the conversation counterpart. It is thus possible to perform smooth bidirectional communication, such as a conversation, between people using different information delivery ways, such as languages.

Specifically, the glasses 1 include the wearer microphone 32 that acquires voice uttered by the wearer. In the conversation translation mode, the voice recognition module 60 recognizes voice acquired by the wearer microphone 32 and converts the voice into text, the translation module 62 translates the text converted by the voice recognition module 60 into a language that the conversation counterpart can recognize, and the external display unit 40 displays the text translated by the translation module 62. Alternatively, in addition to the display, the glasses 1 can also convert the text translated by the translation module 62 into voice by the voice conversion module 64 and deliver the voice converted by the voice conversion module 64 from the front facing speaker 24 to the conversation counterpart. It is thus possible to smoothly deliver what the wearer desires to say to the conversation counterpart between the people using different languages.

Also, the glasses 1 includes the front facing microphone 22 that acquires voice uttered by the conversation counterpart, the voice recognition module 60 recognizes the voice acquired by the front facing microphone 22 and converts the voice into text, the translation module 62 translates the text converted by the voice recognition module 60 into a language that the wearer can recognize, and the internal display unit 38 displays the text translated by the translation module 62.

Alternatively, in addition to the display, the glasses 1 can convert the text translated by the translation module 62 into voice by the voice conversion module 64 and deliver the voice converted by the voice conversion module 64 from the wearer speaker 30 to the wearer. It is thus possible to smoothly deliver what the conversation counterpart desires to say to the wearer between the people using different languages.

Furthermore, the glasses 1 include the camera 20 that captures images in front of the wearer. In the sign language translation mode, the image recognition module 66 recognizes a sign language motion of the conversation counterpart from images acquired by the camera 20 and converts content of a conversation indicated by the sign language motion into text, and the internal display unit 38 displays the text converted by the image recognition module 66. Alternatively, in addition to the display, the glasses 1 can also convert the text converted by the image recognition module 66 into voice by the voice conversion module 64 and deliver the voice converted by the voice conversion module 64 from the wearer speaker 30 to the wearer. It is thus possible to smoothly deliver what the conversation counterpart desires to say to the wearer even in a case where the wearer does not understand the sign language, when conversing with the counterpart who need a conversation using the sign language.

In the image translation mode, the image recognition module 66 can recognize and extract text from images acquired by the camera 20, the translation module 62 can translate the text extracted by the image recognition module 66 into a language that the wearer can recognize, and the internal display unit 38 can display the text translated by the translation module 62. Alternatively, in addition to the display, the voice conversion module 64 can convert the text translated by the translation module 62 into voice, and the wearer speaker 30 can deliver the voice to the wearer. It is thus possible to smoothly acquire information that the wearer desires to obtain in an area where a different language is used.

### Second Embodiment

FIG. 8 illustrates a perspective view of smart glasses 1 according to a second embodiment, and FIG. 9 is a front view of the smart glasses 1 illustrating a text display mode on an external display unit 40 according to the second embodiment. Note that in the following description of each embodiment, configurations that are different from those in the first embodiment will be mainly described and illustration or description may be omitted for configurations similar to those in the first embodiment. A compound lens 42 in the present embodiment is formed in a lens unit 2 that is fixed to the rim 6 constituting the frame 4 of the glasses 1 and has a left side and a right side integrated. In this case, it is possible to secure a wide region to display text 76 in an outer surface 40a of an external display unit 40 in the lens unit 2 with no seams. It is thus possible to collectively display the series of text 76 in several lines on the outer surface 40a as illustrated in FIG. 9. Therefore, it is possible to further smoothly perform bidirectional communication between a wearer and a conversation counterpart and information acquisition of the wearer.

### Third Embodiment

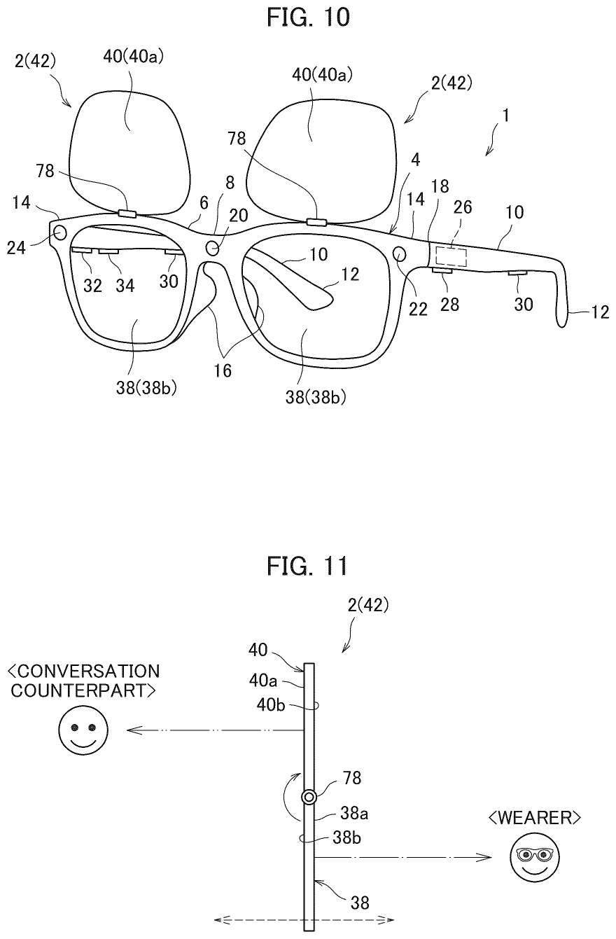

FIG. 10 illustrates a perspective view of smart glasses 1 according to a third embodiment, and FIG. 11 illustrates a schematic view of a lens unit 2 located between a wearer and a conversation counterpart when seen from a side according to the third embodiment. A compound lens 42 in the present embodiment constitutes each of left and right lens units 2 separated via a bridge 8 constituting a frame 4 of the glasses 1 similarly to the case of the first embodiment. An external display unit 40 in each of the left and right lens units 2 in the present embodiment is connected to a rim 6 constituting the frame 4 of the glasses 1 via hinge 78. Also, each external display unit 40 performs display for the conversation counterpart in a state where the external display unit 40 is flipped up in the arrow direction illustrated in FIG. 11 via the hinge 78 with respect to an internal display unit 38. It is possible to display text in an emphasized manner for the conversation counterpart by adopting such flip-up-type glasses 1.

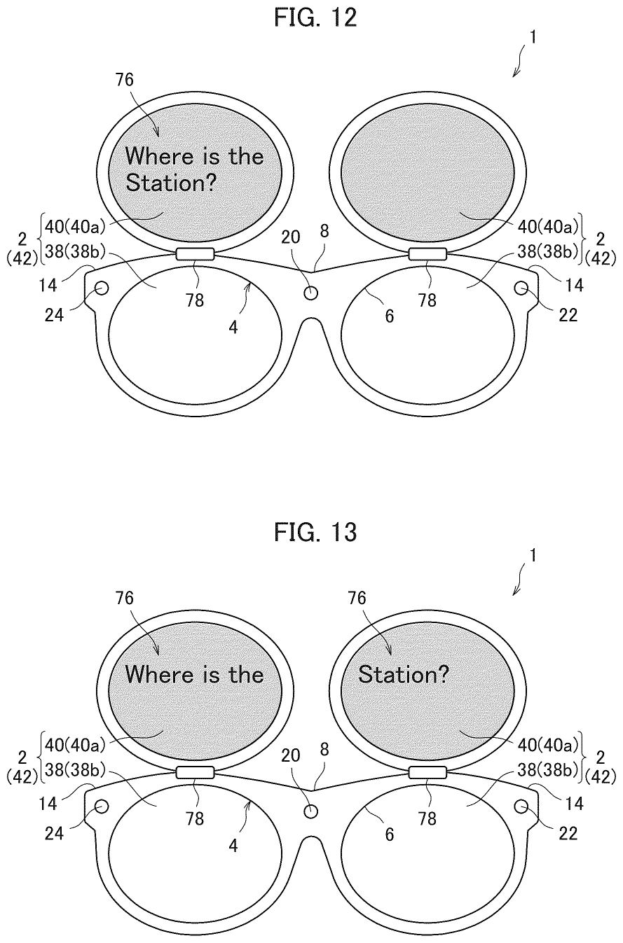

FIG. 12 illustrates a front view of the smart glasses 1 illustrating a text display mode on the external display unit 40 according to the third embodiment, and FIG. 13 illustrates a front view of the smart glasses illustrating another text display mode on the external display unit 40 according to the third embodiment. In the case of the present embodiment, a series of text 76 may be displayed only on an outer surface 40a of the external display unit 40 in a flipped-up state in the lens unit 2 on one side as illustrated in FIG. 12, or display of the series of text 76 on the outer surface 40a of the external display unit 40 in the flipped-up state in the lens unit 2 on one side and display of the next series of text 76 on the outer surface 40a of the external display unit 40 in the flipped-up state in the lens unit 2 on the other side may be sequentially performed.

As illustrated in FIG. 13, it is also possible to perform continuous display of the series of text 76 across the outer surfaces 40a of the external display units 40 in the flipped-up state in both the lens units 2. It is thus possible to further smoothly perform bidirectional communication between the wearer and the conversation counterpart and information acquisition of the wearer by adopting the flip-up-type glasses 1. Note that the external display units 40 in the lens units 2 in the third embodiment may have a configuration in which the external display units 40 are attachable to and detachable from the glasses 1, and with such a configuration, the weight of the glasses 1 is reduced as compared with a case where the external display units 40 are attached, by removing the external display units 40 when they are not used for a conversation and the like.

### Fourth Embodiment

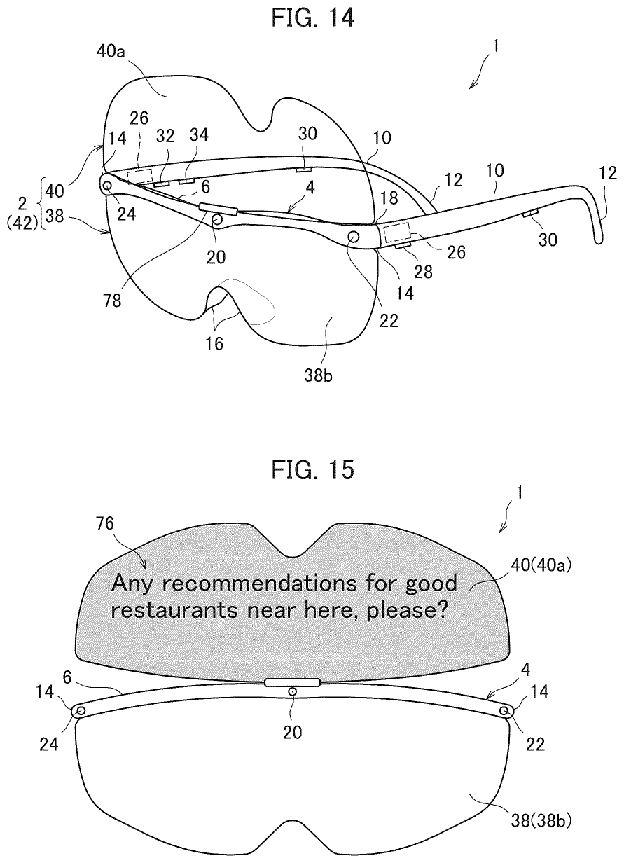

FIG. 14 illustrates a perspective view of smart glasses 1 according to a fourth embodiment, and FIG. 15 illustrates a front view of the smart glasses 1 illustrating a text display mode on an external display unit 40 according to the fourth embodiment. A compound lens 42 in the present embodiment constitutes a lens unit 2 that is fixed to a rim 6 constituting a frame 4 of the glasses 1 and has a left side and a right side integrated, similarly to the second embodiment. Also, the external display unit 40 in the lens unit 2 in the present embodiment is connected to the rim 6 constituting the frame 4 of the glasses 1 via a hinge 78 similarly to the case of the third embodiment.

In the case of the present embodiment, it is possible to secure a wide region to display text 76 on an outer surface 40a of the external display unit 40 in the lens unit 2 with no seams and to collectively display the series of text 76 in several lines on the outer surface 40a as illustrated in FIG. 15. Also, it is possible to display the text in an emphasized manner for the conversation counterpart by adopting the flip-up-type glasses 1. It is thus possible to yet further smoothly perform bidirectional communication between the wearer and the conversation counterpart and information acquisition of the wearer. Note that the external display unit 40 of the lens unit 2 according to the fourth embodiment may have a configuration in which the external display unit 40 is attachable to and detachable from the glasses 1, and with such a configuration, the weight of the glasses 1 is reduced as compared with a case where the external display unit 40 is attached, by removing the external display unit 40 when it is not used for a conversation and the like.

### Fifth Embodiment

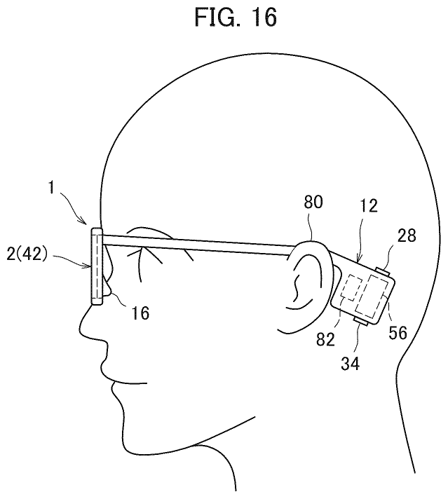

FIG. 16 illustrates a side view of smart glasses 1 according to a fifth embodiment when a wearer wears the smart glasses 1. The glasses 1 include pads 16 and temple tips 12 as previously described, and a power supply unit 56 as described above is incorporated in at least one of the temple tips 12. In this manner, a load of the glasses 1 imparted to each pad 16 is reduced by balancing the weight of the power supply unit 56 and the weight on the side of the compound lenses 42 of the glasses 1 using ears 80 of the wearer as support points. Therefore, it is possible to improve a wearing comfort of the glasses 1 for the wearer. Also, it is possible to increase the battery capacity of the power supply unit 56 by adjusting the balance described above and to thereby realize a long-time operation of the glasses 1.

As illustrated in FIG. 16, operation units 28 and 34 as described above to be operated by the wearer may be disposed at least either above or below the power supply unit 56. It is thus possible to reduce wobbling of the glasses 1 when the operation units 28 and 34 are pressed and operated by adjusting the balance and to thereby improve operability of the glasses 1. Furthermore, a bone conduction unit (voice delivery unit) 82 may be incorporated in at least one of the temple tips 12 instead of the aforementioned wearer speaker 30. It is thus possible to deliver voice to the wearer through vibration delivery to bones in the vicinity of the ears 80 of the wearer. Therefore, it is possible to reliably deliver the voice delivered from the conversation counterpart to the wearer even in a surrounding noisy environment.

Although the embodiments of the present invention have been described hitherto, the present invention is not limited to the embodiments, and various modifications can be made without departing from the gist of the present invention. For example, the aforementioned translation program may be installed in the glasses 1 itself or may be installed in the terminal 72 such as a smartphone, and it is needless to say that the terminal 72 may be another general computer such as a tablet-type, laptop-type, or desktop-type (tower-type) PC.

In addition, the camera 20, the front facing microphone 22, the front facing speaker 24, each wearer speaker 30, the wearer microphone 32, and the operation units 28 and 34 in the glasses 1 are not limited to the aforementioned installation positions, and various installation modes can be assumed.

In addition to the configurations in the aforementioned embodiments, a configuration in which the external display unit 40 of the lens unit 2 is separated from the main body of the smart glasses 1 and is formed as a separate element is also included in the specification. With such a configuration, the external display unit 40 and the internal display unit 38 are separated and are formed as separate elements, and therefore, the external display unit 40 can cause the smart glasses 1 to have a function of displaying information for the conversation counterpart, which is similar to that of the smart glasses with the configurations described in the above embodiments, by being attached to and used with the smart glasses 1 such that the external display unit 40 covers the front surface of the smart glasses 1 (that is, the outer surface 38b of the internal display unit 38) or is put on the front surface.

Note that in the case of this configuration, electrical connection is established between a connector portion and a socket portion that are provided at predetermined locations in the front surface of the smart glasses 1 and the external display unit 40 as a separate element by connecting the connector portion and the socket portion when the external display unit 40 is attached to the front surface of the smart glasses 1, and it is thus only necessary to supply power and a video signal from the main body of the smart glasses 1 to the external display unit 40 via the connection.

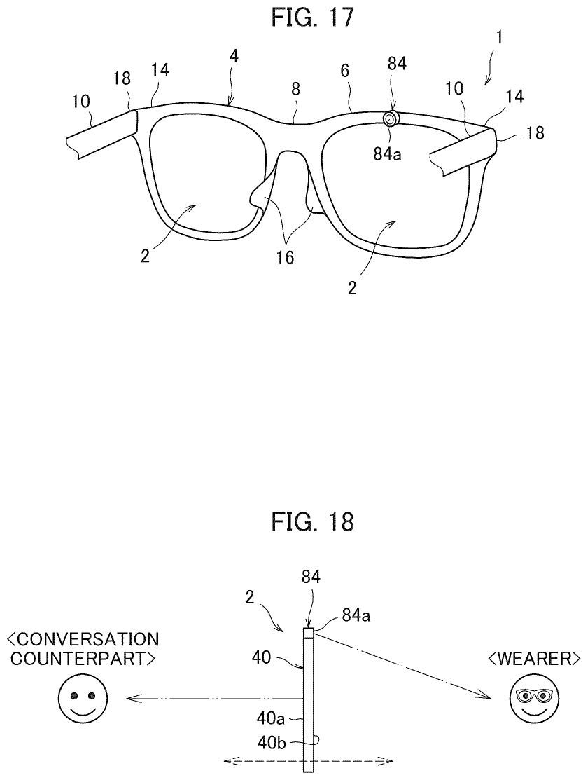

As a technology for displaying information for the wearer of the smart glasses 1, it is possible to apply the projection technologies disclosed in Chinese Utility Model Laid-Open Nos. 220913466 and 221351861 or other technologies for projecting videos directly to eyes of the wearer, such as retinal projection technologies, for example, to the smart glasses 1 in each of the aforementioned embodiments. In the case where the projection technologies disclosed in Chinese Utility Model Laid-Open Nos. 220913466 and 221351861 are used, in particular, the smart glasses 1 include projection-type display equipment (internal display unit) 84 that projects and displays a video (including text) as illustrated in FIG. 17.

The display equipment 84 is provided at an upper portion of the rim 6 constituting the frame 4 of the smart glasses 1, includes an opening portion 84a from which video light is projected directly to the wearer, and displays information from the opening portion 84a for the wearer. In this case, the lens unit 2 is configured only of the external display unit 40 as illustrated in FIG. 18 and does not form the compound lens 42. Therefore, the lens unit 2 can have a simple configuration in the case of this aspect. It is possible to perform smooth bidirectional communication, such as a conversation, between people using different information delivery ways, such as languages, even in the case where such technologies are applied to the smart glasses 1 similarly to the case of each of the aforementioned embodiments.

Moreover, it is possible to apply, in addition to the aforementioned various kinds of video projection and video display, technologies related to information display configured of a video projector, a combiner, and the like to the present invention as technologies to display information for both the wearer of the smart glasses 1 and the conversation counterpart. Note that such technologies related to information display are used in a head-up display (HUD) mounted in a driver seat of an automobile or the like and such technologies can be applied to the external display unit 40 of the smart glasses 1, in particular.

### Reference Signs List

1 Smart glasses
2 Lens unit
4 Frame
6 Rim
8 Bridge
10 Temple
12 Temple tip
16 Pad
20 Camera
22 Front facing microphone (second microphone)
24 Front facing speaker (speaker)
28 Operation unit
30 Wearer speaker (voice delivery unit)
32 Wearer microphone (first microphone)
34 Operation unit
38 Internal display unit
40 External display unit
42 Compound lens
56 Power supply unit
60 Voice recognition module (first voice recognition unit, second voice recognition unit)
62 Translation module (first translation unit, second translation unit, third translation unit)
66 Image recognition module (first image recognition unit, second image recognition unit)
76 Text
78 Hinge
80 Wearer's Ear
82 Bone conduction unit (voice delivery unit)
84 Display equipment (internal display unit)

Although the present invention has been described with reference to preferred embodiments, workers skilled in the art will recognize that changes may be made in form and detail without departing from the spirit and scope of the invention.

1. Smart glasses including a lens unit that allows a wearer to visually recognize a front field of vision, the smart glasses comprising:
an internal display unit that displays information for the wearer; and
a transmission-type external display unit that displays, in the lens unit, information for a conversation counterpart whom the wearer faces.

2. The smart glasses according to claim 1, wherein the internal display unit is provided at an upper portion of a rim constituting a frame of the smart glasses, has an opening portion through which video light is projected directly to the wearer, and displays the information for the wearer from the opening portion.

3. The smart glasses according to claim 1, wherein the lens unit is configured of a compound lens including the internal display unit of a transmission-type that displays the information only for the wearer and the transmission-type external display unit that displays the information only for the conversation counterpart.

4. The smart glasses according to claim 3, wherein the compound lens is formed in the lens unit on each of left and right sides separated via a bridge configuring a frame of the smart glasses.

5. The smart glasses according to claim 3, wherein the compound lens is formed in the lens unit that is fixed to a rim constituting a frame of the smart glasses and has a left side and a right side integrated.

6. The smart glasses according to claim 3,
wherein the external display unit is connected to a rim constituting a frame of the smart glasses via a hinge, and
the external display unit displays the information for the conversation counterpart in a state where the external display unit is flipped up via the hinge with respect to the internal display unit.

7. The smart glasses according to claim 1, further comprising:
a first microphone that acquires voice uttered by the wearer;
a first voice recognition unit that recognizes the voice acquired by the first microphone and converts the voice into text; and
a first translation unit that translates the text converted by the first voice recognition unit into a language that the conversation counterpart is able to recognize,
wherein the text translated by the first translation unit is displayed via the external display unit.

8. The smart glasses according to claim 1, further comprising:
a first microphone that acquires voice uttered by the wearer;
a first voice recognition unit that recognizes the voice acquired by the first microphone and converts the voice into text;
a first translation unit that translates the text converted by the first voice recognition unit into a language that the conversation counterpart is able to recognize;
a first voice conversion unit that converts the text translated by the first translation unit into voice; and
a speaker that delivers the voice converted by the first voice conversion unit to the conversation counterpart.

9. The smart glasses according to claim 1, further comprising:
a second microphone that acquires voice uttered by the conversation counterpart;
a second voice recognition unit that recognizes the voice acquired by the second microphone and converts the voice into text; and
a second translation unit that translates the text converted by the second voice recognition unit into a language that the wearer is able to recognize,
wherein the text translated by the second translation unit is displayed via the internal display unit.

10. The smart glasses according to claim 1, further comprising:
a second microphone that acquires voice uttered by the conversation counterpart;
a second voice recognition unit that recognizes the voice acquired by the second microphone and converts the voice into text;
a second translation unit that translates the text converted by the second voice recognition unit into a language that the wearer is able to recognize;
a second voice conversion unit that converts the text translated by the second translation unit into voice; and
a voice delivery unit that delivers the voice converted by the second voice conversion unit to the wearer.

11. The smart glasses according to claim 1, further comprising:
a camera that captures images in front of the wearer; and
a first image recognition unit that recognizes a sign language motion of the conversation counterpart from the images acquired by the camera and converts content of a conversation indicated by the sign language motion into text,
wherein the text converted by the first image recognition unit is displayed via the internal display unit.

12. The smart glasses according to claim 1, further comprising:
a camera that captures images in front of the wearer;
a first image recognition unit that recognizes a sign language motion of the conversation counterpart from the images acquired by the camera and converts content of conversation indicated by the sign language motion into text;
a third voice conversion unit that converts the text converted by the first image recognition unit into voice; and
a voice delivery unit that delivers the voice converted by the third voice conversion unit to the wearer.

13. The smart glasses according to claim 1, further comprising:
pads that serve as nose pads of the smart glasses; and
temple tips that are formed at distal ends of a pair of temples of the smart glasses, respectively,
wherein a power supply unit that supplies power to the smart glasses is incorporated in at least one of the temple tips.

14. The smart glasses according to claim 13, wherein an operation unit operated by the wearer is disposed in at least one of an upper portion and a lower portion of the temple tips with the power supply unit incorporated therein.
